(19) United States
(12) Patent Application Publication
(10) Pub. No.: US 2008/0140808 A1
(43) Pub. Date: Jun. 12, 2008

(54) SYSTEM AND METHOD FOR MANAGING TRADEMARKS USE

(75) Inventors: CHUNG-I LEE, Tu-Cheng (TW); HAI-HONG LIN, Shenzhen (CN); DE-YI XIE, Shenzhen (CN); HAI-YUN CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/831,969

(22) Filed: Aug. 1, 2007

(30) Foreign Application Priority Data
Dec. 8, 2006 (CN) 200610157362.7

(51) Int. Cl. G06F 15/16

(52) U.S. Cl. 709/219

(57) ABSTRACT

A computer-based method for managing trademarks use is disclosed. The method includes the steps of: setting conditions for obtaining trademark information and setting an execution time for obtaining the trademark information; parsing a webpage on a remote server according to the set conditions, obtaining the trademark information from the webpage, and sorting the obtained trademark information according to the set conditions; uploading evidences of trademarks use to a local server and sorting the uploaded evidences of trademarks use according to the set conditions; setting search conditions, searching in the obtained trademark information and the uploaded evidences of trademarks use according to the search conditions, and judging whether search results are obtained; displaying a list of the search results if the search results are obtained. A related system is also disclosed.

### BACKGROUND OF THE INVENTION

1. Field of the Invention

The present invention is related to a system and method for managing trademarks use.

2. Description of Related Art

Current “trademark searching” services are limited to searching databases of official websites. Many official websites which store the trademarks, such as the United States Patent and Trademark Office (USPTO), are now open to the public. This trademark information stored in the official database can be used to monitor the new registered trademarks, analyze competitor trademark policies and research the trademark trend of the whole industry.

In a traditional way, trademark sorting and the use of trademarks analysis are manually operated by the users. However, the accuracy and efficiency of traditional manual methods are low. When the trademark information (name of each trademark, trademark types, registered countries/regions of the trademark, registered dates, registered products, and an owner of the trademark.) in need of analysis is complex, the process will be difficult and time-consuming. So, it is a need to improve the accuracy and efficiency of management of the use of trademarks.

Therefore, what is needed is a system and method for managing trademarks use which can obtain the trademark information, sort the trademark information and search evidences of the use of the trademarks automatically.

### SUMMARY OF THE INVENTION

A system for managing trademarks use is provided in accordance with a preferred embodiment. The system includes one or more client computers, a local server, and a remote server. The local server connects to the one or more client computers and to the remote server, through a network. The local server includes a setting module, an obtaining module, an uploading module, a sorting module, a searching module, and a displaying module. The setting module is configured for setting conditions for obtaining trademark information and providing an execution time for obtaining the trademark information. The obtaining module is configured for parsing a webpage on the remote server according to the set conditions and obtaining the trademark information from the webpage. The uploading module is configured for uploading evidences of the trademarks use to the local server through one client computer. The sorting module is configured for sorting the obtained trademark information and sorting the uploaded evidences of trademarks use, respectively, according to the set conditions. The searching module is configured for setting search conditions, performing the search on the obtained trademark information and the uploaded evidences according to the search conditions and judging whether search results are obtained. The displaying module is configured for displaying a list of the search results if search results are obtained.

A computer-based method for managing trademarks use is also provided. The method includes the steps of: setting conditions for obtaining trademark information and an execution time for obtaining the trademark information; parsing a webpage on a remote server according to the set conditions, obtaining the trademark information from the webpage, and sorting the obtained trademark information according to the set conditions; uploading evidences of the trademarks use to a local server, and sorting the uploaded evidences of the trademarks use according to the set conditions; setting search conditions, searching in the obtained trademark information and the uploaded evidences of the trademarks use according to the search conditions, and judging whether search results are obtained; displaying a list of the search results if the search results are obtained.

Other systems, methods, features, and advantages of the present invention will become apparent to one with skill in the art upon examination of the following drawings and detailed description.

### BRIEF DESCRIPTION OF THE DRAWINGS

FIG. 1 is a schematic diagram of hardware configuration of a system for managing trademarks use in accordance with a preferred embodiment; and

FIG. 2 is a flowchart of a preferred method for managing trademarks use in accordance with one embodiment.

### DETAILED DESCRIPTION OF THE INVENTION

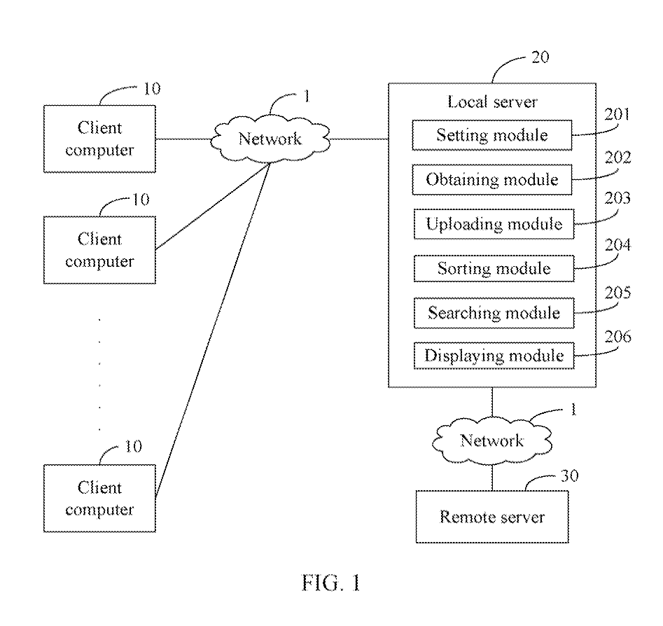

FIG. 1 is a schematic diagram of hardware configuration of a system for managing trademarks use (hereinafter, “the system”) in accordance with a preferred embodiment. The system typically includes one or more client computers 10, a local server 20, and a remote server 30. The local server 20 connects to the client computers 10 and the remote server 30, through a network 1. Each client computer 10 can be a personal computer (PC) or a notebook. The local server 20 can be a blade server, a tower server or any other suitable kind of server. The remote server 30 can be a server including a website of an official organization, such as the United States Patent and Trademark Office (USPTO), which provides users with trademark information. The remote server 30 can also be a server including a website of a commercial organization, such as Yahoo.

The local server 20 may include a setting module 201, an obtaining module 202, an uploading module 203, a sorting module 204, a searching module 205, and a displaying module 206.

The setting module 201 is configured for setting conditions for obtaining trademark information from the remote server 30 and an execution time for obtaining the trademark information through the client computer 10 when reaching the execution time. Information of a trademark may include a name of the trademark (i.e., a Logo of the trademark), a trademark type, a registered country/region of the trademark, a registered date, registered products, and an owner (or coowners) of the trademark. The conditions may include a website of the remote server 30 and keywords to obtain the trademark information. The keywords may include at least part of the trademark information, such as an owner of the trademark (a company or a person) and/or registered products of the trademark. For example, when there is a need to obtain the trademark information of company A and company B from the USPTO, the website of the remote server 30 can be set as USPTO and the keywords can be as A and B.

The obtaining module 202 is configured for parsing a webpage on the remote server 30 according to the set conditions and obtaining the trademark information from the webpage. More specifically, at first the obtaining module 202 parses the webpage of the website on the remote server 30 according to the keywords set by the setting module 201 when reaching the execution time. Then, the obtaining module 202 obtains the trademark information from the webpage on the remote server 30, and stores the webpage and the trademark information in the local server 20. If no website is set by the setting module 201, the obtaining module 202 accesses a default website (such as the USPTO or any other website) that provides the trademark information.

The uploading module 203 is configured for uploading evidences of the trademarks use to the local server 20 through the client computer 10. The evidences of the trademarks use may be obtained or copied from a newspaper or a magazine using the trademark information (such as a Logo of a corresponding trademark) or other situations that the trademark information is used in public. An administrator of the trademarks can upload information such as an image of an item clipped from the newspaper or the magazine, a publication date of the newspaper or the magazine, an owner of the used trademarks, an uploaded date, and an uploaded person to the local server 20. The obtained trademark information and the uploaded evidences can be stored in the same database table or different database tables of the local server 20. If the obtained trademark information and the uploaded evidences of trademarks use are stored in the same database table, a specified field in the database table can be used to differentiate the obtained trademark information and the uploaded evidences of trademarks use.

The sorting module 204 is configured for sorting the obtained trademark information and the uploaded evidences of the trademarks use respectively, according to the corresponding set conditions. The set conditions may include the keywords to obtain the trademark information. Therefore, the sorting module 204 can sort the obtained trademark information and the uploaded evidences of trademarks use respectively, according to the corresponding keywords. For example, when the obtaining module 202 obtains the trademark information of company A and company B, the sorting module 204 sorts the trademark information of company A and company B according to the company name. When evidences of the trademarks use of company A and company B are uploaded, the sorting module 204 also sorts the evidences according to the company name.

The searching module 205 is configured for setting search conditions, searching in the obtained trademark information and the uploaded evidences of trademarks use according to the search conditions, and judging whether search results are obtained (i.e., judging whether trademark information or evidences of trademarks use are obtained in accordance with the search conditions). The search conditions may include at least part of the trademark information, such as a name of a trademark, a trademark type, registered country/region of the trademark, a registered date, registered products, and an owner of the trademark. For example, if there is a need to analyze whether there are the evidences of using a trademark owned by company A, in the searched conditions, the owner of the trademark can be set as A. Then, the searching module 205 searches in the obtained trademark information and the uploaded evidences according to the search conditions, and judges whether search results are obtained.

The displaying module 206 is configured for displaying a list of the search results (i.e., the trademark information and the evidences of trademarks use in accordance with the search conditions). The contents of the list may include trademark information of each trademark and evidences of each trademark use. According to the contents of the list, infringement of a trademark can be easily identified. If no results are obtained by the searching module 205, the displaying module 206 displays information showing that no results are found.

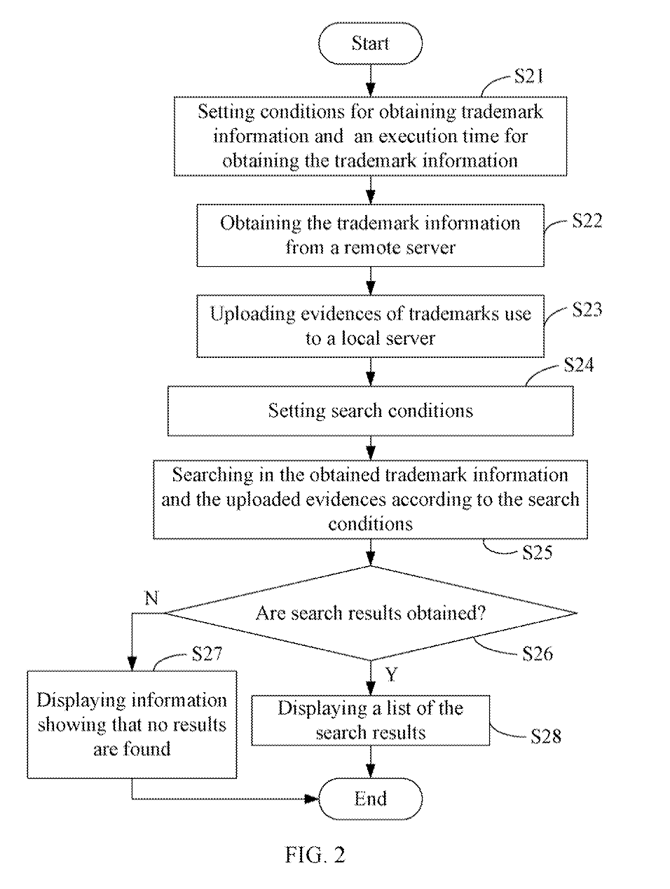

FIG. 2 is a flowchart of a preferred method for managing trademarks use in accordance with one embodiment. In step S21, the setting module 201 sets conditions for obtaining trademark information from the remote server 30 and an execution time for obtaining the trademark information through a client computer 10. Information of a trademark may include a name of the trademark (i.e., a Logo of the trademark), a trademark type, a registered country/region of the trademark, a registered date, registered products, and an owner of the trademark. The conditions may include the website of the remote server 30 and keywords to obtain the trademark information. The keywords may include at least part of the trademark information, such as an owner of the trademark (a company or a person) and/or registered products of the trademark.

In step S22, the obtaining module 202 parses a webpage on the remote server 30, according to the keywords, when reaching the execution time. Then, the module 202 obtains the trademark information from the webpage, and stores the webpage and the trademark information in the local server 20. Following which, the sorting module 204 sorts the obtained trademark information according to the keywords. If no website is set by the setting module 201, the obtaining module 202 accesses a default website (such as the USPTO or any other website) that provides the trademark information.

In step S23, the uploading module 203 uploads evidences of trademarks use to the local server 20 through the client computer 10. Then, the sorting module 204 sorts the uploaded evidences of trademarks use according to the keywords. The evidences of trademarks use may be obtained or copied from a newspaper or a magazine using the trademark information (such as a Logo of a corresponding trademark) or other situations that the trademark information is used in public. An administrator of the trademarks can upload information such as an image of an item clipped from the newspaper or the magazine, a publication date of the newspaper or the magazine, an owner of the used trademarks, an uploaded date, and an uploaded person to the local server 20.

In step S24, the administrator sets search conditions via the searching module 205.

In step S25, the searching module 205 searches in the obtained trademark information and the uploaded evidences of trademarks use according to the search conditions. The searched conditions may include at least part of the trademark information, such as a name of a trademark, a trademark type, a registered country/region of the trademark, a registered date, registered products, and an owner of the trademark.

In step S26, the searching module 205 judges whether search results are obtained (i.e., judging whether trademark information or evidences of trademarks use in accordance with the search conditions are obtained).

If no results are obtained, in step S27, the displaying module 206 displays information showing that no results are found.

If search results are obtained, in step S28, the displaying module 206 displays a list of the search results (i.e., the trademark information and the evidences of trademarks use in accordance with the search conditions). The contents of the list may include trademark information of each trademark and evidences of trademarks use. According to the contents of the list, infringement of a corresponding trademark can be easily identified.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for managing trademarks use, the system comprising one or more client computers, a local server, and a remote server, the local server being connected to the one or more client computers and the remote server through a network, the local server comprising:
a setting module configured for setting conditions for obtaining trademark information and an execution time for obtaining the trademark information;
an obtaining module configured for parsing a webpage on the remote server according to the set conditions and obtaining the trademark information from the webpage;
an uploading module configured for uploading evidences of the trademarks use to the local server through one client computer;
a sorting module configured for sorting the obtained trademark information and the uploaded evidences of trademarks use respectively according to the set conditions;
a searching module configured for setting search conditions, searching in the obtained trademark information and the uploaded evidences of trademarks use according to the search conditions, and judging whether search results are obtained; and
a displaying module configured for displaying a list of the search results if the search results are obtained.

2. The system according to claim 1, wherein the displaying module is further configured for displaying information showing that no results are found if no results are obtained by the searching module.

3. The system according to claim 1, wherein the trademark information includes a name of each trademark, a trademark type, a registered country/region of the trademark, a registered date, registered products, and an owner of the trademark.

4. The system according to claim 3, wherein the search conditions includes at least part of the trademark information.

5. The system according to claim 1, wherein the set conditions include a website of the remote server and keywords to obtain the trademark information.

6. A computer-based method for managing trademarks use, the method comprising:
setting conditions for obtaining trademark information and an execution time for obtaining the trademark information;
parsing a webpage on a remote server according to the set conditions, obtaining the trademark information from the webpage, and sorting the obtained trademark information according to the set conditions;
uploading evidences of trademarks use to a local server, and sorting the uploaded evidences of trademarks use according to the set conditions;
setting search conditions, searching in the obtained trademark information and the uploaded evidences of trademarks use according to the search conditions, and
judging whether search results are obtained; and
displaying a list of the search results if the search results are obtained.

7. The method according to claim 6, further comprising:
displaying information showing that no results are found if no results are obtained.

8. The method according to claim 6, wherein the trademark information includes a name of each trademark, a trademark type, a registered country/region of the trademark, a registered date, registered products, and an owner of the trademark.

9. The method according to claim 8, wherein the search conditions includes at least part of the trademark information.

10. The method according to claim 6, wherein the set conditions include a website of the remote server and keywords to obtain the trademark information.
